(19) United States
(12) Patent Application Publication
(10) Pub. No.: US 2017/0013101 A1
(43) Pub. Date: Jan. 12, 2017

(54) WATERPROOF HOUSING

(71) Applicant: ICHIA TECHNOLOGIES,INC., Taoyuan County (TW)

(72) Inventors: MING-SHAN CHEN, TAOYUAN CITY (TW); SHIH-FU YU, NEW TAIPEI CITY (TW); CHIH-PIN LIN, NEW TAIPEI CITY (TW); CHIH-HAO HSU, TAOYUAN CITY (TW)

(21) Appl. No.: 14/792,664

(22) Filed: Jul. 7, 2015

(51) Int. Cl. H04M 1/18

(52) U.S. Cl. CPC H04M 1/185

(57) ABSTRACT

A waterproof housing without any screwing structure includes a top waterproof module, a waterproof gasket disposed on the top waterproof module, and a bottom waterproof module detachably combined with the top waterproof module. The top waterproof module has a top case, a transparent plate, and a resilient film. The top case has a touch-control window and a fingerprint hole, the transparent plate is fixed on the inner surface of the top case and entirely shields the touch-control window, and the resilient film is fixed between the inner surface of the top case and the transparent plate to shield the fingerprint hole. When a smart phone is received in the waterproof housing, the resilient film can be pressed to trigger the fingerprint function of the smart phone. The top and bottom waterproof modules are combined with each other to compress the waterproof gasket.

### BACKGROUND OF THE INVENTION

1. Field of the Invention

The instant invention relates to a waterproof housing; in particular, to a waterproof housing for covering a smart phone having a fingerprint key.

2. Description of Related Art

With advances in technology, electronic devices are gradually provided with at least one camera, and people can take a picture at any time using the electronic device. The electronic device may be a smart phone. Some kinds of smart phones are advertised with a waterproof function, but the effect of the waterproof function is very limited. If the smart phone is actually operating in water, the water is prone to penetrate into the smart phone so as to cause a damage problem. Furthermore, in order to prevent the above damage problem to the smart phone, the user often puts the smart phone into a waterproof housing to achieve a waterproof effect by the waterproof housing.

However, the conventional waterproof housing is often provided with a waterproof function by a screwing manner, such that the installation of the conventional waterproof housing is more complicated, and the volume of the conventional waterproof housing is too large with respect to the smart phone. Furthermore, the waterproof housing also needs to be improved according to the smart phone, for example the waterproof housing cannot influence new functions of the smart phone (such as: fingerprint function).

To solve the abovementioned problem, the inventors strive via industrial experience and academic research to present the instant disclosure, which can solve the problem as mentioned above.

### SUMMARY OF THE INVENTION

The instant disclosure provides a waterproof housing for effectively improving the problem generated from the conventional waterproof housing.

The instant disclosure provides a waterproof housing formed without any screwing structure for receiving a smart phone having a fingerprint key, comprising: a top waterproof module, comprising a top case having a top plate and a top side plate perpendicularly extended from an edge of the top plate, the top plate having a touch-control window and a fingerprint hole, wherein the top plate has a retaining portion formed on an inner surface thereof, the retaining portion is arranged adjacent to the top side plate, and the top side plate and the retaining portion cooperatively define an annular groove, wherein the top case has a top wedging portion formed on the inner surface of the top side plate; a transparent plate fixed on the inner surface of the top plate and arranged inside the retaining portion, wherein the transparent plate entirely shields the touch-control window, and the transparent plate does not shield the fingerprint hole; and a resilient film, wherein an edge of the resilient film is fixed between the inner surface of the top plate and the transparent plate, and the resilient film shields the fingerprint hole, wherein when the smart phone is received in the waterproof housing, a portion of the resilient film corresponding to the fingerprint hole is configured to be pressed to generate a flexible deformation for touching the fingerprint key of the smart phone, such that the waterproof housing does not influence the operation of the fingerprint key of the smart phone; a waterproof gasket arranged in the annular groove, wherein a portion of the waterproof gasket protrudes from the annular groove; a bottom waterproof module detachably combined with the top waterproof module, comprising: a bottom case having a bottom plate and a bottom side plate perpendicularly extended from an edge of the bottom plate, wherein an end surface of the bottom side plate arranged away from the bottom plate is defined as an abutting surface, the bottom case has a bottom wedging portion formed on an outer surface of the bottom side plate, wherein the top waterproof module is detachably combined with the bottom waterproof module by wedging the top wedging portion to the bottom wedging portion, the waterproof gasket is pressed by the abutting surface of the bottom case and the bottom of the annular groove of the top case, and the pressed waterproof gasket seamlessly abuts against the abutting surface of the bottom case and the bottom of the annular groove of the top case.

In summary, the waterproof housing of the instant disclosure houses a smart phone without any screwing manner or structure, thereby reducing the volume of the waterproof housing and increasing the using convenience of the waterproof housing. Specifically, the top case and the bottom case are combined with each other by the cooperation of the top wedging portion and the bottom wedging portion, thus the waterproof gasket is pressed by the top case and the bottom case to achieve waterproof effect.

Moreover, when the smart phone is received in the waterproof housing, the waterproof housing does not influence the operation of the fingerprint key of the smart phone by setting the resilient film.

In order to further appreciate the characteristics and technical contents of the instant invention, references are hereunder made to the detailed descriptions and appended drawings in connection with the instant invention. However, the appended drawings are merely shown for exemplary purposes, rather than being used to restrict the scope of the instant invention.

### BRIEF DESCRIPTION OF THE DRAWINGS

FIG. 1 is a perspective view showing a waterproof housing according to the instant disclosure;

FIG. 2 is a perspective view showing the waterproof housing from another perspective;

FIG. 3 is an exploded view of the waterproof housing;

FIG. 4 is an exploded view of the waterproof housing from another perspective;

FIG. 5 is an exploded view of the top waterproof module and the waterproof gasket;

FIG. 6 is an exploded view of the top waterproof module and the waterproof gasket from another perspective;

FIG. 7 is a cross-sectional view of FIG. 1 along line 7-7; and

FIG. 8 is a cross-sectional view of FIG. 1 along line 8-8.

### DETAILED DESCRIPTION OF THE PREFERRED EMBODIMENTS

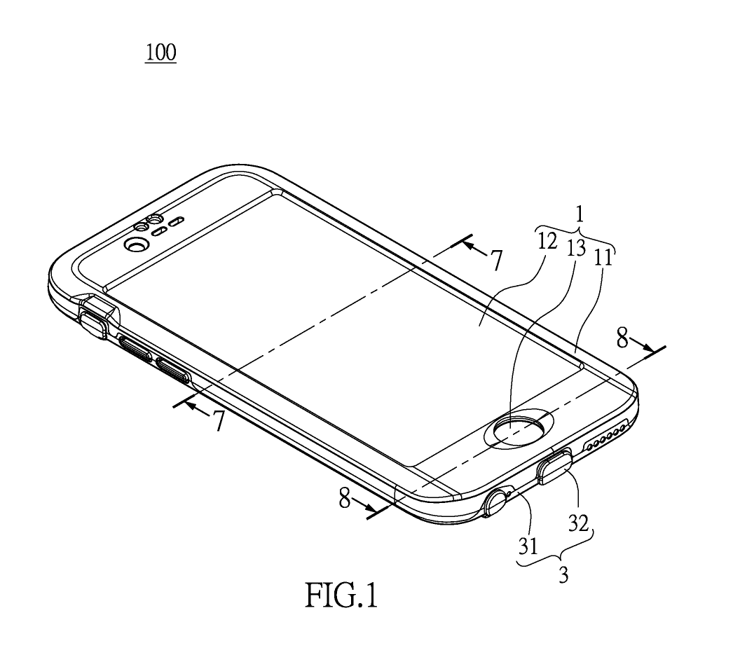

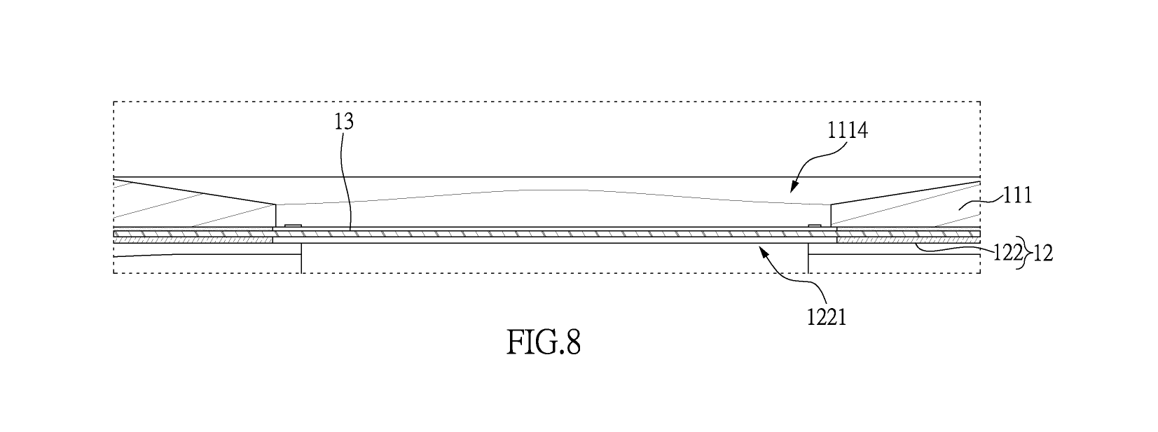

Please refer to FIGS. 1 through 8, which show an embodiment of the instant disclosure. References are hereunder made to the detailed descriptions and appended drawings in connection with the instant invention. However, the appended drawings are merely shown for exemplary purposes, rather than being used to restrict the scope of the instant invention.

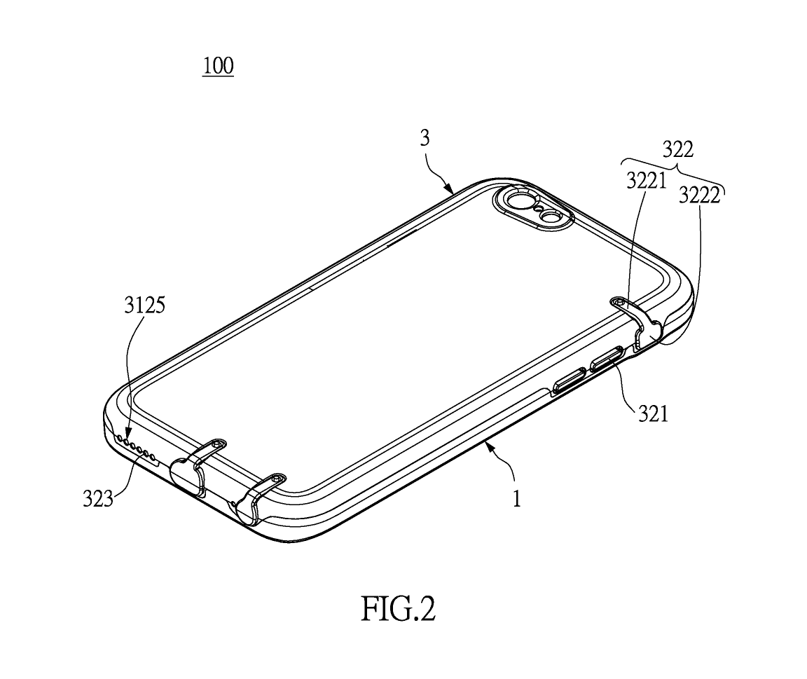

Please refer to FIGS. 1 and 2, which show a waterproof housing 100 formed without any screwing structure of the instant embodiment. The waterproof housing 100 of the instant embodiment houses a smart phone (not shown) without any screwing manner or structure, thereby reducing the volume of the waterproof housing 100 and increasing the using convenience of the waterproof housing 100. Moreover, the waterproof housing 100 of the instant embodiment is provided for receiving a smart phone (not shown) having a fingerprint key, and the waterproof housing 100 does not influence the operation of the fingerprint key of the smart phone.

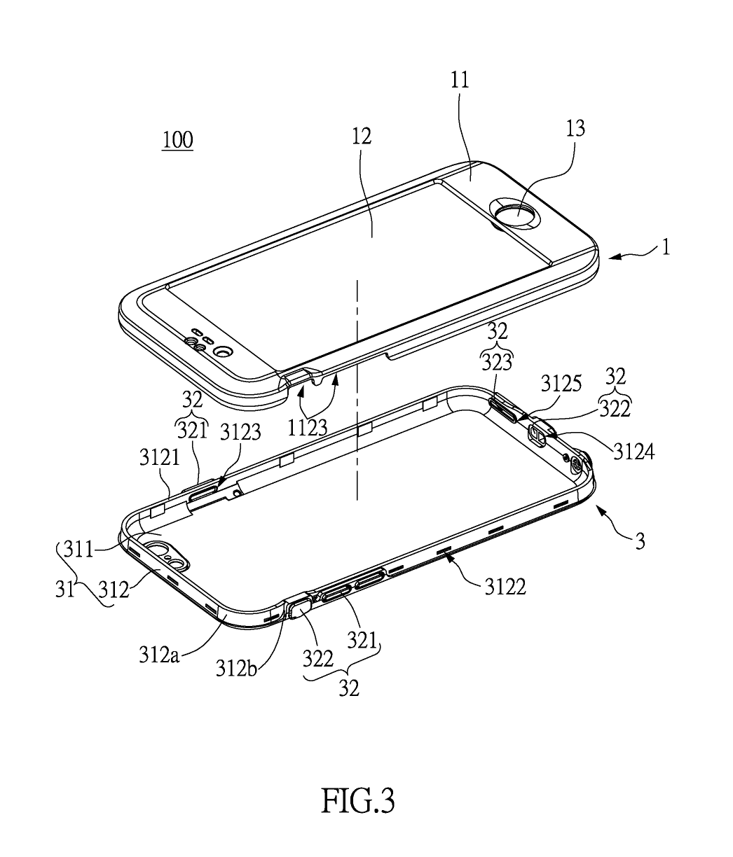

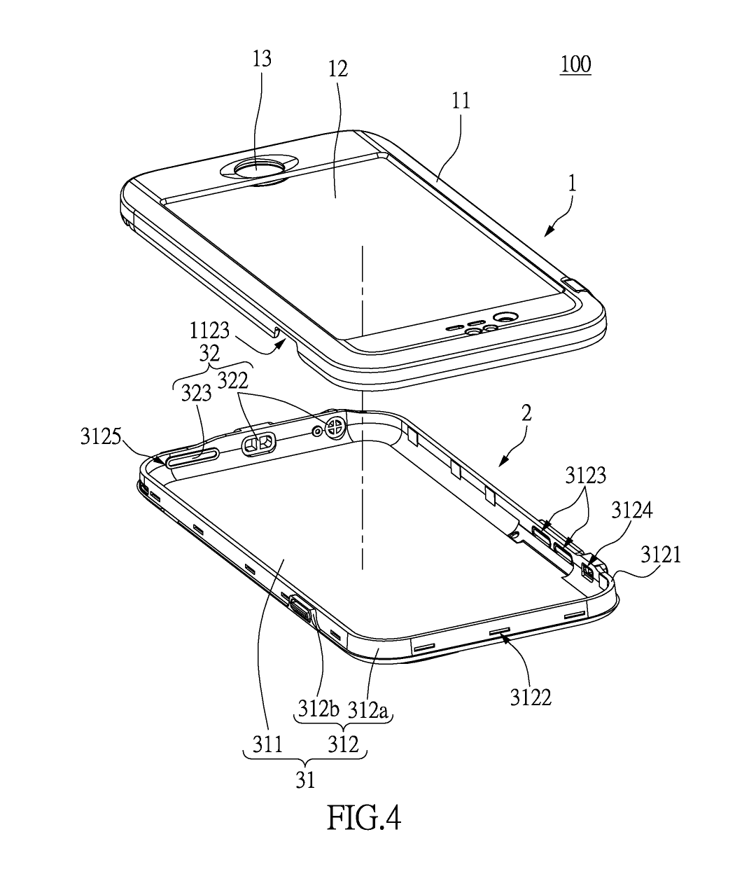

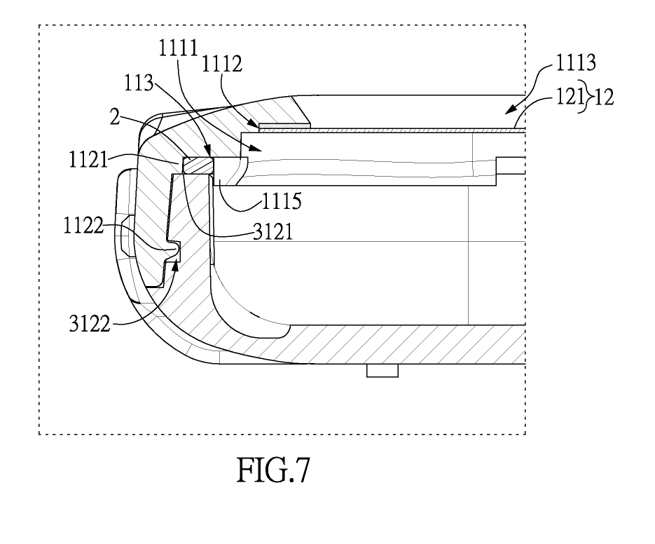

As shown in FIGS. 3 and 4, the waterproof housing 100 includes a top waterproof module 1, a waterproof gasket 2 disposed on the top waterproof module 1 (as shown in FIG. 7), and a bottom waterproof module 3 detachably wedged to the top waterproof module 1. The top waterproof module 1 and the bottom waterproof module 3 are wedged with each other to cooperatively press the waterproof gasket 2, thus the waterproof gasket 2 can seamlessly abut against the top waterproof module 1 and the bottom waterproof module 3, thereby avoiding water from flowing into the waterproof housing 100 via a connecting portion between the top waterproof module 1 and the bottom waterproof module 3.

In order to clearly disclose the construction of the waterproof housing 100, the following description discloses the construction of the top waterproof module 1, the waterproof gasket 2, and the bottom waterproof module 3, and then discloses the relationship there-between.

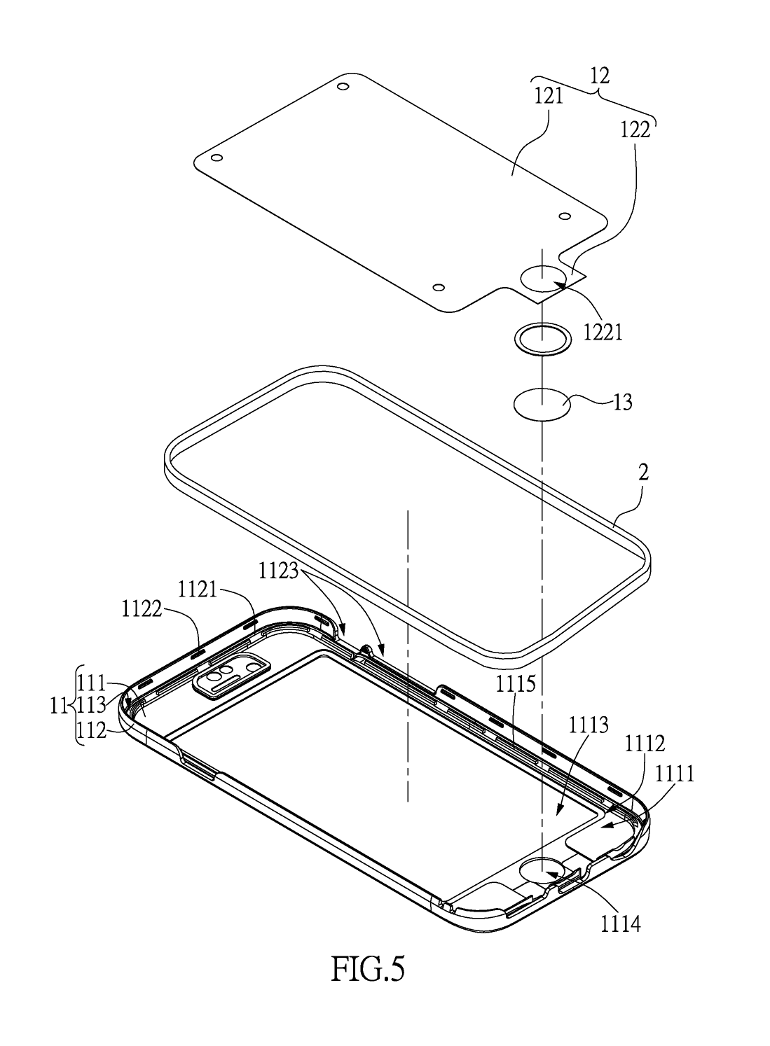

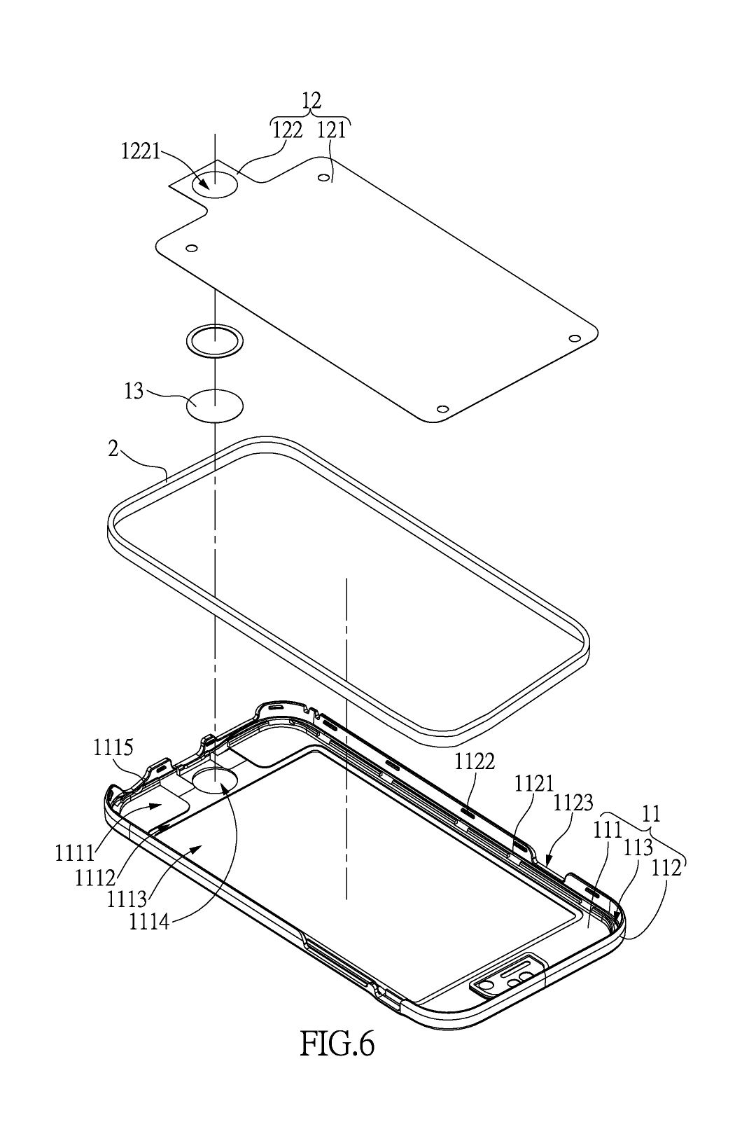

As shown in FIGS. 5 and 6, the top waterproof module 1 includes a top case 11, a transparent plate 12 disposed on the top case 11, and a resilient film 13 fixed between the top case 11 and the transparent plate 12. The top case 11 has a rectangular top plate 111 and an annular top side plate 112 perpendicularly extended from the edge of the top plate 111.

As shown in FIGS. 6 and 7, an accommodating trough 1111 is formed on an inner surface of the top plate 111, and the size of the accommodating trough 1111 is suitable to receive the smart phone. A receiving trough 1112 is formed on a bottom of the accommodating trough 1111, and the receiving trough 1112 has a rectangular touch-control window 1113 and a circular fingerprint hole 1114 arranged apart from the touch-control window 1113. When the smart phone is inserted into the accommodating trough 1111, the touch-control window 1113 aligns a touch-control portion of the smart phone, and the fingerprint hole 1114 aligns the fingerprint key of the smart phone.

Moreover, the top plate 111 has a retaining portion 1115 formed on the inner surface thereof, and the retaining portion 1115 is arranged adjacent to the top side plate 112 and arranged outside the accommodating trough 1111. In other words, the accommodating trough 1111 is formed on a portion of the inner surface of the top plate 111, in which the portion is arranged inside the retaining portion 1115. The retaining portion 1115 in the instant embodiment includes a plurality of columns arranged around the accommodating trough 1111. An annular groove 113 is defined by the retaining portion 1115 and the top side plate 112. The top side plate 112 has a limited portion 1121 (as shown in FIG. 7) arranged on an inner side thereof and integrally connected to the top plate 111, and the limited portion 1121 in the instant embodiment has an annular shape. The annular groove 113 is arranged between the limited portion 1121 of the top side plate 112 and the retaining portion 1115 of the top plate 111.

Please refer to FIGS. 6 through 8. The transparent plate 12 approximately conforms in shape to the receiving trough 1112. The transparent plate 12 in the instant embodiment has a main portion 121 and an extending portion 122 integrally extended from the main portion 121, and the extending portion 122 has a circular hole 1221 corresponding to the fingerprint hole 1114. The edge of the transparent plate 12 is fixed on (i.e., adhered to) the inner surface of the top plate 111 of the top case 11 and is arranged inside the retaining portion 1115. Specifically, the edge of the transparent plate 12 is adhered to the bottom of the receiving trough 1112, the transparent plate 12 entirely shields the touch-control window 1113, and the circular hole 1221 of the extending portion 122 aligns with the fingerprint hole 1114, so the transparent plate 12 does not shield the fingerprint hole 1114. Moreover, the bottom surface of the accommodating trough 1111 and the transparent plate 12 are in a coplanar arrangement, thus the front surface of the smart phone can be disposed on the bottom surface of the accommodating trough 1111 and the transparent plate 12. The shape of the transparent plate 12 can be changed based on the designer's request, and the transparent plate 12 is not limited to the figures of the instant embodiment.

The resilient film 13 is larger than the fingerprint hole 1114 of the top case 11 and is also larger than the circular hole 1221 of the transparent plate 12. The edge of the resilient film 13 is fixed between the inner surface of the top plate 111 and the transparent plate 12, and the resilient film 13 shields the circular hole 1221 of the transparent plate 12 and the fingerprint hole 1114 of the top case 11. In other words, a center portion of the resilient film 13 is exposed from the transparent plate 12 and the top case 11 via the circular hole 1221 and the fingerprint hole 1114. Specifically, the resilient film 13 is arranged in the receiving trough 1112, one side of the edge of the resilient film 13 is adhered to the bottom of the receiving trough 1112, and another side of the edge of the resilient film 13 is pressed by the extending portion 122 of the transparent plate 12, thus the resilient film 13 is fixed between the bottom of the receiving trough 1112 and the extending portion 122 of the transparent plate 12.

Moreover, when the smart phone is received in the waterproof housing 100 (not shown), the center portion of the resilient film 13 corresponding to the fingerprint hole 1114 can be pressed by a user to generate a flexible deformation, thereby touching the fingerprint key of the smart phone. Thus, the waterproof housing 100 does not influence the operation of the fingerprint key of the smart phone.

The waterproof gasket 2 is arranged in the annular groove 113 of the top case 11, and a portion of the waterproof gasket 2 protrudes from the annular groove 113. That is to say, the portion of the waterproof gasket 2 protrudes from the retaining portion 1121 of the top case 11, thus the bottom waterproof module 3 can press the protruding portion of the waterproof gasket 2 easily.

As shown in FIGS. 3 and 4, the bottom waterproof module 3 includes a bottom case 31 and a plurality of waterproof members 32. The bottom waterproof module 3 is formed by the double injection manner to connect the waterproof members 32 and the bottom case 31. The bottom case 31 has a rectangular bottom plate 311 and an annular bottom side plate 312 perpendicularly extended from an edge of the bottom plate 311. An end surface of the bottom side plate 312 arranged away from the bottom plate 311 (i.e., the top end surface of the bottom side plate 312 as shown in FIG. 3) is defined as an abutting surface 3121.

Specifically, as shown in FIGS. 4, 6, and 7, the top case 11 has a top wedging portion 1122 formed on the inner surface of the top side plate 112, the bottom case 31 has a bottom wedging portion 3122 formed on the outer surface of the bottom side plate 312, and the top wedging portion 1122 can be wedged to the bottom wedging portion 3122. In the instant embodiment, the top wedging portion 1122 includes a plurality of ridges, and the bottom wedging portion 3122 includes a plurality of concaves. However, the top wedging portion 1122 and the bottom wedging portion 3122 can be changed based on the designer's request, and the top wedging portion 1122 and the bottom wedging portion 3122 are not limited to the instant embodiment. For example, the top wedging portion 1122 can be a plurality of concaves (not shown), and the bottom wedging portion 3122 can be a plurality of ridges (not shown).

Furthermore, the top case 11 of the top waterproof module 1 is combined with the bottom case 31 of the bottom waterproof module 3 by wedging the top wedging portion 1122 to the bottom wedging portion 3122 (i.e., respectively inserting the ridges into the concaves), and the abutting surface 3121 of the bottom case 31 abuts against the limited portion 1121 of the top case 11 and is arranged outside the retaining portion 1115 (as shown in FIG. 7), so the waterproof gasket 2 is pressed by the abutting surface 3121 of the bottom case 31 and the bottom of the annular groove 113 of the top case 11. Thus, the pressed waterproof gasket 2 seamlessly abuts against the abutting surface 3121 of the bottom case 31 and the bottom of the annular groove 113 of the top case 11, thereby causing a seamless connection between the waterproof gasket 2 and the abutting surface 3121 and a seamless connection between the waterproof gasket 2 and the bottom of the annular groove 113.

The waterproof housing 100 of the instant embodiment has some waterproof constructions for the other functional keys (e.g., volume button and switch button), the inserting jacks (e.g., power jack and earphone jack), and the voice holes (e.g., listening holes) of the smart phone, and the waterproof construction of the waterproof housing 100 is disclosed as follows.

As shown in FIGS. 4 and 6, the bottom side plate 312 includes an inner segment 312a and a plurality of functional segments 312b integrally extended from part of the outer surface of the inner segment 312a. The inner segment 312a has an annular construction, and the functional segments 312b are protruding from part of the outer surface of the inner segment 312a, so the thickness of part of the bottom side plate 312 having the inner segment 312a and the functional segments 312b is greater than the thickness of another part of the bottom side plate 312 only having the inner segment 312a. The bottom wedging portion 3122 is formed on the part of the outer surface of the inner segment 312a which is not extending the functional segments 312b, and at least two concaves of the bottom wedging portion 3122 are respectively arranged on two opposite sides of each functional segment 312b. The abutting surface 3121 is the end surface of the inner segment 312a arranged away from the bottom plate 311 (i.e., the top end surface of the inner segment 312a as shown in FIG. 4).

The inner profile of the top side plate 112 is slightly larger than the outer profile of the inner segment 312a of the bottom side plate 312, and the top side plate 112 has a plurality of notches 1123 respectively conforming in shape to the functional segments 312b. Each functional segment 312b can be wedged to the corresponding notch 1123. Moreover, at least two ridges of the top wedging portion 1122 are respectively arranged on two opposite sides of each notch 1123.

Thus, when the top case 11 is wedged to the bottom case 31, the top side plate 112 covers the part of the outer surface of the inner segment 312a which is not extending the functional segments 312b, the functional segments 312b are respectively received in the notches 1123, and the outer surface of the bottom side plate 312 aligns with the outer surface of the top side plate 112, thereby the waterproof housing 100 has a smooth outer surface (as shown in FIGS. 1 and 2). Moreover, a portion of the top case 11 arranged adjacent to each notch 1123 can be firmly connected to the bottom case 31 by combining the ridges arranged adjacent to the corresponding notch 1123 with the concavities arranged adjacent to the corresponding functional segment 312b.

In more detail, the functional segments 312b are configured to respectively correspond to the functional keys (e.g., volume button and switch button), the inserting jacks (e.g., power jack and earphone jack), and the voice holes (e.g., listening holes) of the smart phone. The functional segments 312b in the instant embodiment include at least one button hole 3123, at least one connector hole 3124, and at least one sound hole 3125. The waterproof members 32 are corresponding to the functional segments 312b and include at least one waterproof soft key 321, at least one waterproof cork 322, and at least one waterproof and breathable film 323.

The waterproof soft key 321 is arranged in the button hole 3123. The waterproof cork 322 has a fixing portion 3221 fixed on the bottom plate 311 (as shown in FIG. 2) and a sealing portion 3222, which is insertable into the connector hole 3124. The waterproof and breathable film 323 is fixed on the bottom side plate 312, and the position of the waterproof and breathable film 323 corresponds to the sound hole 3125. Moreover, the waterproof soft key 321, the waterproof cork 322, and the waterproof and breathable film 323 are formed by the double injection manner to combine with the bottom case 31.

In summary, the waterproof housing of the instant disclosure can house a smart phone without any screwing manner or structure, thereby reducing the volume of the waterproof housing and increasing the using convenience of the waterproof housing. Specifically, the top case and the bottom case are combined with each other by the cooperation of the top wedging portion and the bottom wedging portion, thus the waterproof gasket is pressed by the top case and the bottom case to achieve waterproof effect. The portion of the top case arranged adjacent to each notch can be firmly connected to the bottom case by combining the ridges arranged adjacent to the corresponding notch with the concavities arranged adjacent to the corresponding functional segment.

Moreover, when the smart phone is received in the waterproof housing, by setting the resilient film the waterproof housing does not influence the operation of the fingerprint key of the smart phone.

Additionally, the waterproof members (i.e., the waterproof soft key, the waterproof cork, and the waterproof and breathable film) of the instant disclosure is formed by the double injection manner to combine with the bottom case, thereby effectively reducing the cost of the waterproof housing and increasing the production of the waterproof housing.

The descriptions illustrated supra set forth simply the preferred embodiments of the instant invention; however, the characteristics of the instant invention are by no means restricted thereto. All changes, alterations, or modifications conveniently considered by those skilled in the art are deemed to be encompassed within the scope of the instant invention delineated by the following claims.

[symbol]

100 [symbol] waterproof housing
1 [symbol] top waterproof module
11 [symbol] top case
   111 [symbol] top plate
      1111 [symbol] accommodating trough
      1112 [symbol] receiving trough
      1113 [symbol] touch-control window
      1114 [symbol] fingerprint hole
      1115 [symbol] retaining portion
   112 [symbol] top side plate
      1121 [symbol] limited portion
      1122 [symbol] ( [symbol] ) top wedging portion (e.g., ridge)
      1123 [symbol] notch
   113 [symbol] annular groove
12 [symbol] transparent plate
   121 [symbol] main portion
   122 [symbol] extending portion
      1221 [symbol] circular hole
13 [symbol] resilient film
   2 [symbol] waterproof gasket
   3 [symbol] bottom waterproof module
31 [symbol] bottom case
   311 [symbol] bottom plate
   312 [symbol] bottom side plate
      312a [symbol] inner segment
      312b [symbol] functional segment
      3121 [symbol] abutting surface
      3122 [symbol] ( [symbol] ) bottom wedging portion (e.g., concave)
      3123 [symbol] button hole
      3124 [symbol] connector hole
      3125 [symbol] sound hole
32 [symbol] waterproof member
   321 [symbol] waterproof soft key
   322 [symbol] waterproof cork
      3221 [symbol] fixing portion
      3222 [symbol] sealing portion
   323 [symbol] waterproof and breathable film

What is claimed is:

1. A waterproof housing formed without any screwing structure for receiving a smart phone having a fingerprint key, comprising:
a top waterproof module, comprising
a top case having a top plate and a top side plate perpendicularly extended from an edge of the top plate, the top plate having a touch-control window and a fingerprint hole, wherein the top plate has a retaining portion arranged on an inner surface thereof, the retaining portion is arranged adjacent to the top side plate, and the top side plate and the retaining portion cooperatively define an annular groove, wherein the top case has a top wedging portion formed on the inner surface of the top side plate;
a transparent plate fixed on the inner surface of the top plate and arranged inside the retaining portion, wherein the transparent plate entirely shields the touch-control window, and the transparent plate does not shield the fingerprint hole; and
a resilient film, wherein an edge of the resilient film is fixed between the inner surface of the top plate and the transparent plate, and the resilient film shields the fingerprint hole,
wherein when the smart phone is received in the waterproof housing, a portion of the resilient film corresponding to the fingerprint hole is configured to be pressed to generate a flexible deformation for touching the fingerprint key of the smart phone, such that the waterproof housing does not influence the operation of the fingerprint key of the smart phone;
a waterproof gasket arranged in the annular groove, wherein a portion of the waterproof gasket protrudes from the annular groove;
a bottom waterproof module detachably combined with the top waterproof module, comprising:
a bottom case having a bottom plate and a bottom side plate perpendicularly extended from an edge of the bottom plate, wherein an end surface of the bottom side plate arranged away from the bottom plate is defined as an abutting surface, the bottom case has a bottom wedging portion formed on an outer surface of the bottom side plate,
wherein the top waterproof module is detachably combined with the bottom waterproof module by wedging the top wedging portion to the bottom wedging portion, the waterproof gasket is pressed by the abutting surface of the bottom case and the bottom of the annular groove of the top case, and the pressed waterproof gasket seamlessly abuts against the abutting surface of the bottom case and the bottom of the annular groove of the top case.

2. The waterproof housing as claimed in claim 1, wherein the bottom side plate has an inner segment and a plurality of functional segments integrally extended from part of an outer surface of the inner segment, the bottom wedging portion is formed on another part of the outer surface of the inner segment, and the abutting surface is an end surface of the inner segment arranged away from the bottom plate, wherein the top side plate has a plurality of notches respectively corresponding to the functional segments, the functional segments are respectively inserted into the notches, and an outer surface of the bottom side plate aligns an outer surface of the top side plate.

3. The waterproof housing as claimed in claim 2, wherein the top wedging portion has a plurality of ridges, the bottom wedging portion has a plurality of concaves, and the ridges are respectively received in the concaves.

4. The waterproof housing as claimed in claim 3, wherein at least two of the ridges are respectively arranged on two opposite sides of each notch, and at least two of the concaves are respectively arranged on two opposite sides of each functional segment.

5. The waterproof housing as claimed in claim 4, wherein the functional segments has at least one button hole, and the bottom waterproof module has at least one waterproof soft key arranged in the button hole.

6. The waterproof housing as claimed in claim 5, wherein the functional segments has at least one connector hole, the bottom waterproof module has at least one waterproof cork, and the waterproof cork has a fixing portion fixed on the bottom plate and a sealing portion, the sealing portion is insertable into the connector hole.

7. The waterproof housing as claimed in claim 6, wherein the functional segments has at least one sound hole, and the bottom waterproof module has at least one waterproof and breathable film fixed on the bottom side plate, and the position of the waterproof and breathable film corresponds to the sound hole.

8. The waterproof housing as claimed in claim 7, wherein the waterproof soft key, the waterproof cork, and the waterproof and breathable film are formed by a double injection manner to combine with the bottom case.

9. The waterproof housing as claimed in claim 1, wherein the top plate has an accommodating trough formed on the inner surface thereof, and the accommodating trough is arranged inside the retaining portion, a receiving trough is formed on a bottom of the accommodating trough, the transparent plate is arranged in the receiving trough, and the transparent plate and the bottom of the accommodating trough are substantially in a coplanar arrangement.

10. The waterproof housing as claimed in claim 1, wherein the top side plate has a limited portion connected to the top plate, the annular groove is arranged between the retaining portion and the limited portion, and the abutting surface abuts against the limited portion and is arranged out of the retaining portion.
